(19) United States
(12) Patent Application Publication
(10) Pub. No.: US 2026/0008613 A1
(43) Pub. Date: Jan. 8, 2026

(54) LOGISTICS SYSTEM AND METHOD FOR AUTOMATING LOADING AND DISCHARGING USING TRANSFER ROBOTS

(71) Applicant: CJ LOGISTICS CORPORATION, Seoul (KR)

(72) Inventors: Hyun Ho LEE, Seoul (KR); Mun Seok JANG, Seoul (KR); Jin Hyeong KIM, Seoul (KR)

(21) Appl. No.: 19/256,223

(22) Filed: Jul. 1, 2025

(30) Foreign Application Priority Data
Jul. 3, 2024 (KR) 10-2024-0087261

(51) Int. Cl. B65G 1/04; B66F 9/075; G06T 7/70

(52) U.S. Cl. CPC B65G 1/0435; B66F 9/0755; G06T 7/70; B65G 2203/0233; B65G 2203/041; G06T 2207/30164

(57) ABSTRACT

An embodiment of the present disclosure relates to a logistics system configured to automate loading and discharging using a transfer robot. The logistics system may include a transfer robot configured to perform loading or discharging on a rack and move to a set position, and a loading/discharging device arranged at one side of a conveyor and including a mechanical part configured to discharge an item loaded on the rack onto the conveyor or load an item fed to the conveyor on the rack by moving the item. In addition, various embodiments may be performed.

### CROSS REFERENCE TO RELATED APPLICATION OF THE DISCLOSURE

The present application claims the benefit of Korean Patent Application No. 10-2024-0087261 filed in the Korean Intellectual Property Office on Jul. 3, 2024, the entire contents of which are incorporated herein by reference.

### BACKGROUND OF THE DISCLOSURE

### Field of the Disclosure

The present disclosure relates to a logistics system configured to automate loading of an item from a conveyor onto a rack of a transfer robot using the transfer robot and discharging of a loaded item onto the conveyor, and a method of automating loading and discharging in the logistics system.

### Background of the Related Art

Recently, as introduction of automation into logistics systems is increasing, a process of transferring items using transfer robots is expanding. Meanwhile, workers in the logistics systems need to handle a process of moving items that have been loaded on a transfer robot to a conveyor to discharge the items, or loading items that have been fed to a conveyor onto a transfer robot. Thus, high-intensity physical labor is needed.

In the logistics systems, musculoskeletal diseases or safety accidents may occur to workers due to highly difficult physical labor. In addition, current logistics systems require different working hours for respective workers. Thus, there is such a problem that it is difficult to secure operational stability, such as maintaining productivity or predicting a throughput.

Accordingly, by reflecting such problems, the present disclosure is to provide a logistics system and method for automating loading and discharging using a transfer robot

### PRIOR ART DOCUMENT

### Patent Documents

(Patent document 1) Korea Patent No. 10-2248439 (published on May 6, 2021)

### SUMMARY OF THE DISCLOSURE

Accordingly, the present disclosure has been made in view of the above-mentioned problems occurring in the related art, and it is an object of the present disclosure to provide a logistics system and a method of operation in the logistics system, the logistics system including a transfer robot attached to a rack and a loading/discharging device arranged at one side of a conveyor to automate loading and discharging in the logistics system, and configured to, by the loading/discharging device, discharge an item that has been loaded on the rack to the conveyor or load an item that has been fed to the conveyor on the rack by moving the item.

The present disclosure may, however, be embodied in many different forms and should not be construed as being limited to the embodiments set forth herein. Additional aspects will be set forth in part in the description which follows and, in part, will be apparent from the description, or may be learned by practice of the presented exemplary embodiments.

To accomplish the above-mentioned objects, according to an embodiment of the present disclosure, there is provided a logistics system configured to automate loading and discharging using a transfer robot, the logistics system may include: a transfer robot configured to perform loading or discharging on a rack and move to a set position; and a loading/discharging device arranged at one side of a conveyor, and including a mechanical part configured to discharge an item loaded on the rack to the conveyor or load an item fed to the conveyor on the rack by moving the item.

According to an embodiment of the present disclosure, the mechanical part may include: a clamp configured to lift and fix the item; an X-axis slider, a Y-axis fork and a Z-axis lift configured to move a position of the item fixed to the clamp along an X-axis, a Y-axis and a θ-axis, respectively, in correspondence with position information which is set previously; and a swing fork configured to transfer the item fixed to the clamp at an angle corresponding to the set position information.

According to an embodiment of the present disclosure, the loading/discharging device may detect occurrence of a loading/discharging event for discharging or loading the item by performing communication with the conveyor or the transfer robot; and further include a processor configured to lay out the transfer robot to dock the rack on the loading/discharging device, as the loading/discharging event occurs, and a vision camera configured to obtain a vision image.

According to an embodiment of the present disclosure, when the rack is docked on the loading/discharging device, the processor may control the vision camera to obtain a vision image for a plurality of holes provided in the rack, identify a hole position for the plurality of holes based on the vision image, calculate a distance and an angle by which the hole position is located apart from a preset reference position, and transmit a correction value including the calculated distance and angle to the mechanical part.

According to an embodiment of the present disclosure, the processor may control the Z-axis lift to move the mechanical part to a height corresponding to the hole position when the loading/discharging event is a first loading/discharging event for discharging a first item from the rack, control the clamp to fix the first item when the mechanical part moves to the hole position, control the X-axis slider, the Y-axis fork and the swing fork to move and rotate the first item fixed to the clamp by a distance and an angle according to the correction value, and control the mechanical part to discharge the first item that has been moved and rotated according to the correction value to the conveyor.

According to an embodiment of the present disclosure, when the loading/discharging event is a second loading/discharging event for loading a second item that has been fed to the conveyor onto the rack, the processor may control the clamp to fix the second item, control the Z-axis lift to move the second item fixed to the clamp to a height corresponding to the hole position, control the X-axis slider, the Y-axis fork and the swing fork to move and rotate the second item fixed to the clamp by a distance and an angle according to the correction value, and control the mechanical part to load, onto the conveyor, the second item that has been moved and rotated according to the correction value.

In addition, according to an embodiment of the present disclosure, a method of automating loading and discharging using a transfer robot in a loading/discharging device of a logistics system may include: communicating with a transfer robot attached to a conveyor or a rack connected to the loading/discharging device; as a result of the communication, detecting occurrence of a loading/discharging event for discharging an item loaded on the rack to the conveyor or loading the item that has been fed to the conveyor on the rack; and laying out the transfer robot to dock the rack on the loading/discharging device, as the loading/discharging event occurs.

According to an embodiment of the present disclosure, the method may further include, when the rack is determined as having been docked on the loading/discharging device, obtaining a vision image of a plurality of holes provided in the rack using a vision camera.

According to an embodiment of the present disclosure, the method may further include identifying a hole position for the plurality of holes based on the vision image; calculating a distance and an angle by which the hole position is spaced apart from a preset reference position; and checking a correction value including the calculated distance and angle.

According to an embodiment of the present disclosure, the method may further include controlling the item to be moved to a height corresponding to the hole position, the item that has been moved to the hole position to be moved and rotated by a distance and an angle according to the correction value, and the item that has been moved and rotated according to the correction value to be discharged to the conveyor or loaded on the rack, by using a mechanical part of the loading/discharging device.

### BRIEF DESCRIPTION OF THE DRAWINGS

The above and other objects, features and advantages of the present disclosure will be apparent from the following detailed description of the embodiments of the disclosure in conjunction with the accompanying drawings, in which:

FIG. 1 is a diagram illustrating a configuration of a logistics system that automates loading and discharging using a transfer robot according to an embodiment of the present disclosure;

FIG. 2 is a block diagram illustrating a configuration of the transfer robot according to an embodiment of the present disclosure;

FIG. 3 is a block diagram illustrating a configuration of a loading/discharging device according to an embodiment of the present disclosure;

FIG. 4 is a side view of the loading/discharging device according to an embodiment of the present disclosure;

FIG. 5 is a diagram illustrating an X-axis slider included in a functional part of the loading/discharging device according to an embodiment of the present disclosure;

FIG. 6 is a diagram illustrating a Y-axis fork included in the functional part of the loading/discharging device according to an embodiment of the present disclosure;

FIG. 7 is a diagram illustrating a Z-axis lift included in the functional part of the loading/discharging device according to an embodiment of the present disclosure;

FIG. 8 is a diagram illustrating a rotational θ-axis unit included in the functional part of the loading/discharging device according to an embodiment of the present disclosure;

FIG. 9 is a diagram illustrating a vision image captured to check a position of an item in the loading/discharge device according to an embodiment of the present disclosure;

FIG. 10 is a diagram illustrating a vision image captured to determine a hole position spaced apart from a reference position in the loading/discharge device according to an embodiment of the present disclosure;

FIG. 11 is a flowchart illustrating an operation of automating, by the loading/discharge device, loading and discharging in the logistics system according to an embodiment of the present disclosure; and

FIG. 12 is a flowchart illustrating an operation of moving, by the loading/discharge device, an item based on a vision image in the logistics system according to an embodiment of the present disclosure.

### DETAILED DESCRIPTION OF THE PREFERRED EMBODIMENT

Hereinafter, embodiments of the present disclosure are described in detail with reference to the accompanying drawings. Advantages and features of the present disclosure and methods of accomplishing the same may be understood more readily with by reference to the following detailed description of embodiments and the accompanying drawings. However, the present disclosure is not limited to the embodiments set forth herein, and may be embodied in many different forms. The embodiments are provided so that this disclosure will be thorough and complete, and will fully convey the concept of the present disclosure to those skilled in the art, and the scope of the present disclosure should be defined by the appended claims. Like reference numerals denote like elements throughout this specification.

Unless defined otherwise, all the terms (including technical and scientific terms) used in this specification may be used as meanings that may be commonly understood by those skilled in the art. In addition, terms defined in commonly used dictionaries are not interpreted ideally or excessively unless clearly and specially defined. As used herein, the term is intended to describe the embodiments but is not intended to limit the present disclosure. In this specification, the singular includes the plural unless specifically stated otherwise.

It will be further understood that the terms “comprises,” “comprising,” “includes,” and/or “including,” when used herein, mean that the mentioned components, steps, operations, and/or elements do not exclude the presence or addition of one or more other components, steps, operations and/or elements.

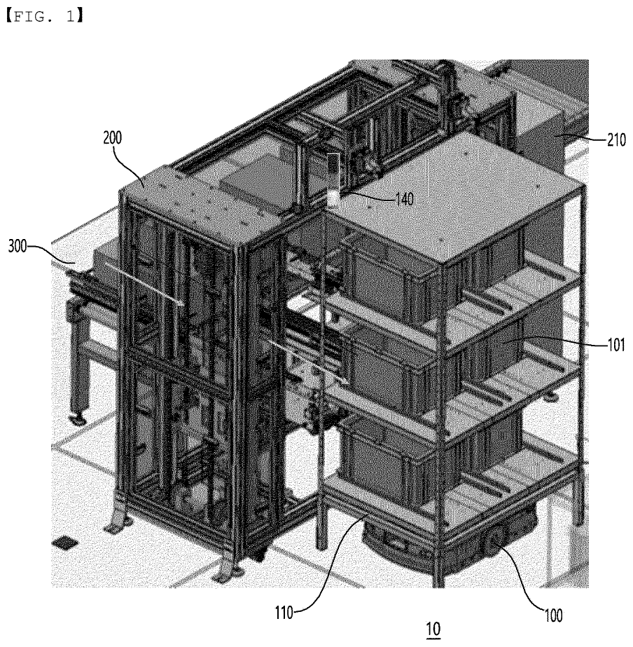

FIG. 1 is a diagram illustrating a configuration of a logistics system that automates loading and discharging using a transfer robot according to an embodiment of the present disclosure.

Referring to FIG. 1, a logistics system 10 may include a transfer robot 100, a loading/discharge device 200, and a conveyor 300. The logistics system 10 may perform a loading/discharge operation of loading, by the transfer robot 100, an item of the loading/discharge device 200 or discharging a loaded item to the conveyor 300 through the loading/discharge device 200. Here, the item may mean a box which is pre-standardized, or an item loaded in the box.

According to an embodiment of the present disclosure, the transfer robot 100 is a robot device capable of moving according to a control command, and transfers a rack 101. For example, the transfer robot 100 may move to a position of the rack 101 or the loading/discharging device 200 designated according to a control command in the logistics system 10.

According to an embodiment of the present disclosure, in the logistics system 10, the transfer robot 100 and the loading/discharging device 200 may detect occurrence of a loading/discharging event. The loading/discharging event may be a control command for discharging an item loaded on the rack 101 to the conveyor 300 through the loading/discharging device 200, or loading an item that has been fed into the conveyor 300 onto the rack 101.

According to an embodiment of the present disclosure, the transfer robot 100 may include an input/output unit (e.g., a touch display) (not shown). Through the input/output unit, a user may directly input a control command or detect occurrence of a loading/discharging event according to control by an upper-level system. In addition, when a classifying operation of items fed from the conveyor 300 is performed, the loading/discharging device 200 connected to the conveyor 300 may determine that a loading/discharging event for loading an item that has been fed to the conveyor 300 onto the rack 101 has occurred. Then, the transfer robot 100 and the loading/discharging device 200 may perform communication to transmit, to another device, a message notifying that the loading/discharging event has occurred.

According to an embodiment of the present disclosure, a light emission device (LED) 140 that indicates a state of the transfer robot 100 (e.g., moving, loading or discharging, stopping, or problem occurrence) may be attached to the tote equipment. For example, a control server 400 may check a light emission setting preset according to a state of the transfer robot 100 and control the LED 140 to emit light based on a light emission color, light emission time, and a blinking cycle according to the corresponding light emission setting. Accordingly, a user of the logistics system 10 may identify a state of the transfer robot 100 depending on whether the LED 140 emits light.

According to an embodiment of the present disclosure, the loading/discharging device 200 may include a mechanical part connected to the conveyor 300 to load an item that has been fed through the conveyor 300 onto the rack 101 or to move an item loaded onto the rack 101 to be discharged onto the conveyor 300. In addition, the loading/discharging device 200 may obtain a vision image of the rack 101 to calculate position information of the item to be discharged, and control a position or an angle of the mechanical part to be adjusted according to the position information.

According to an embodiment of the present disclosure, when the loaded item are finally transferred to the conveyor 300 and reach an end, the logistics system 10 may allow a worker to manually take the item or transfer the item to a next stage (e.g., a packaging stage or a delivery stage). Meanwhile, the conveyor 300 may be an initial starting point of an item to be fed to the logistics system 10. At this time, the conveyor 300 may perform a task of selecting a type of the item and classifying the item according to a position onto which the item is loaded or discharged.

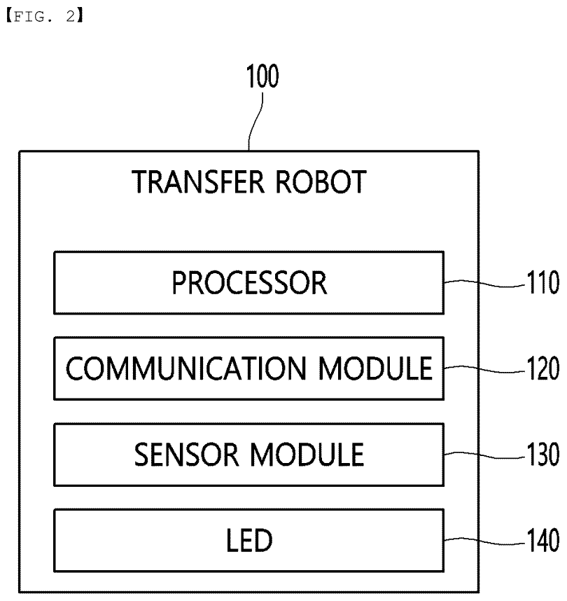

FIG. 2 is a block diagram illustrating a configuration of the transfer robot according to an embodiment of the present disclosure.

Referring to FIG. 2, the transfer robot 100 may include a processor 110, a communication module 120, a sensor module 130, and the LED 140.

According to an embodiment of the present disclosure, the processor 110 may control all operations of the transfer robot 100. For example, the processor 110 may perform communication with the loading/discharging device 200 to detect a loading/discharging event, lay out movement of the transfer robot 100 to dock the rack 101 attached to the transfer robot 100 on the loading/discharging device 200, detect whether the docking on the loading/discharging device 200 has been performed, and control light emission data notifying a state of the transfer robot 100 to be output.

According to an embodiment of the present disclosure, the communication module 120 may communicate with devices (e.g., the loading/discharging device 200, the conveyor 300) in the logistics system 10. The processor 110 may determine whether a loading/discharging event has occurred in the logistics system 10 as a result of performing the communication.

According to an embodiment of the present disclosure, the sensor module 130 may be provided as a plurality of sensors in various positions in the transfer robot 100. A proximity sensor, a motion sensor, a touch sensor, an acceleration sensor, an image sensor, etc. may be used as the sensor module 130. In addition, various sensors for detecting movement of the transfer robot 100 or the rack 101 and proximity to the loading/discharging device 200 may be may be further provided.

According to an embodiment of the present disclosure, the LED 140 may be an element that outputs light emission data according to preset a light emission setting. For example, the light emission setting may include setting information for setting luminous intensity, a color temperature, power consumption, time, or a light emission cycle, and in addition to this, may also include various settings related to light emission of the LED 140.

According to an embodiment of the present disclosure, when a state of the transfer robot 100 corresponds to a pre-designated state (e.g., moving, loading, discharging, stopping, problem occurrence), the processor 110 may control the LED 140 to emit light according to a light emission setting pre-designated for the corresponding state. Accordingly, a user of the logistics system 10 may determine the state of the transfer robot 100 by checking light emission data of the LED 140.

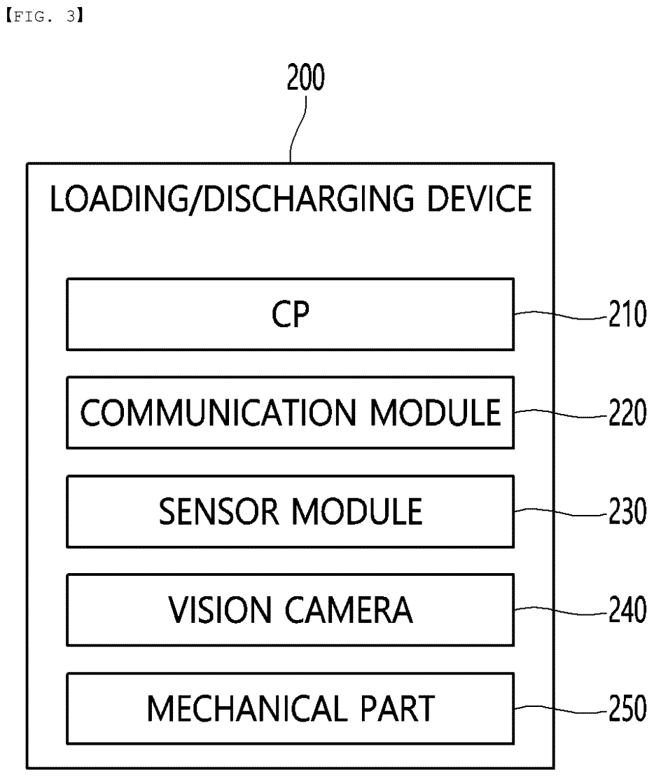

FIG. 3 is a block diagram illustrating a configuration of the loading/discharging device according to an embodiment of the present disclosure.

Referring to FIG. 3, the loading/discharging device 200 may include a central processor (CP) 210, a communication module 220, a sensor module 230, a vision camera 240, and a mechanical part 250.

According to an embodiment of the present disclosure, the CP 210 may control all operations of the loading/discharging device 200. For example, the CP 210 may detect a loading/discharging event in a logistics system 10, detect whether the rack 101 of the transfer device 100 has been docked in correspondence with the loading/discharging event, obtain a vision image of the rack 101 when the rack 101 has been docked, check a position of a hole in the rack 101 and a distance and an angle with respect to the hole position based on the vision image, and control the mechanical part 250 according to the checked position and angle to load an item on the rack 101 or discharge a loaded item onto the conveyor 300.

According to an embodiment of the present disclosure, the sensor module 230 may include an alignment sensor to determine whether the hole position in the rack 101 is in a reference position or at a reference angle. The alignment sensor may detect a position or a direction of an item using light. Additionally, the sensor module 230 may include an optical sensor, an ultrasonic sensor, a laser sensor, a contact sensor, or the like to determine docking of the rack 101 and a position and an alignment state of an item loaded on the rack 101.

According to an embodiment of the present disclosure, the vision camera 240 may include a plurality of image sensors or cameras for obtaining a vision image. The vision image may be a plurality of images containing various information when processed and interpreted by the CP 210. For example, the vision camera 240 may obtain a vision image including not only basic image information (e.g., pixels, colors, contrast and brightness information), but also texture of a surface that appears in an image, a shape or a spatial position of a subject photographed in the image, heat distribution of the subject, movement or a high-speed process with respect to the subject, three-dimensional (3D) depth information obtained using a plurality of lenses, etc.

According to an embodiment of the present disclosure, the CP 210 may obtain a vision image of the rack 101 by the vision camera 240, and analyze the vision image to check a hole position in the rack 101 and a distance or an angle by which the hole position is spaced apart from a preset reference position.

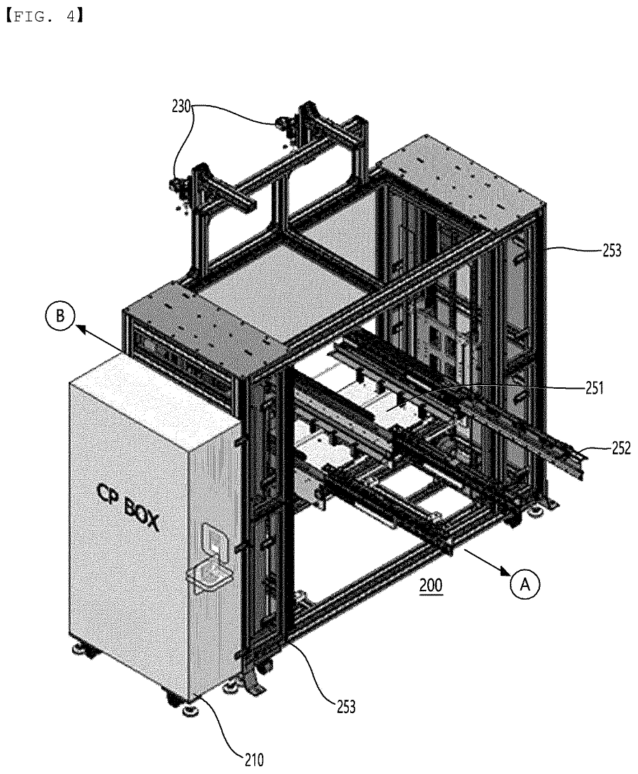

According to an embodiment of the present disclosure, the mechanical part 250 may be coupled to a plurality of components 251 to 254 (of FIGS. 4 to 8) of the mechanical part 250 through an actuator (e.g., an electric motor, a hydraulic cylinder, or a piston), generate a control command of the CP 210 as a control command for the actuator, and control the actuator according to the control command to control movement of the components 251 to 254.

FIG. 4 is a side view of the loading/discharging device according to an embodiment of the present disclosure.

Referring to FIG. 4, the loading/discharging device 200 includes the CP 210. According to a control by the CP 210, the vision camera 240 is controlled to obtain a vision image, and an X-axis slider 251, a Y-axis fork (or a telescopic fork) 252, a Z-axis lift 253, and a swing fork may be controlled.

According to an embodiment of the present disclosure, when the loading/discharging device 200 is viewed from a side, the Y-axis fork 252 arranged on the X-axis slider 251 may be identified.

According to an embodiment of the present disclosure, the Z-axis lift 253 may be coupled to both sides of the X-axis slider 251. In detail, the Z-axis lift 253 is coupled to a fork 202 of the X-axis slider 251 and may move the fork 202 along a Z-axis to move an item positioned on the fork 202 upward or downward.

According to an embodiment of the present disclosure, the loading/discharging device 200 may be coupled to the conveyor 300 in a direction A and docked with the rack 101 in a direction B. For example, when a loaded item is to be discharged, the loading/discharging device 200 may move the item from the rack 101 docked in the direction B and discharge the item to the conveyor 300 coupled in the direction A. On the other hand, when an item that has been fed is to be loaded, the loading/discharging device 200 may check the fed item through the conveyor 300 coupled in the direction A and load the item onto the rack 101 docked in the direction B.

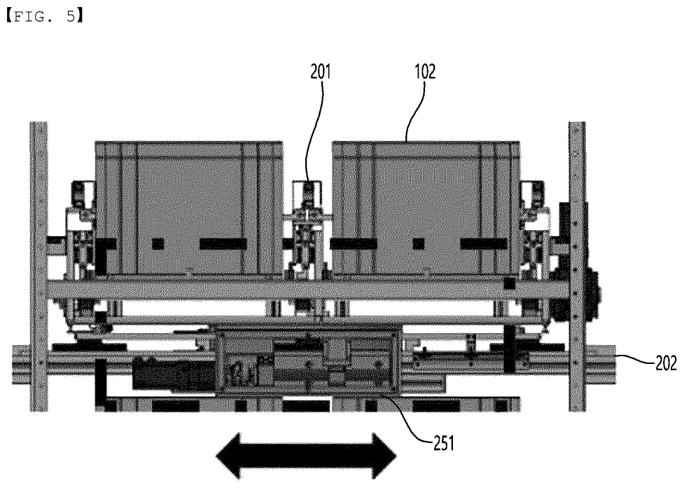

FIGS. 5 to 8 are diagrams illustrating components included in a functional part of the loading/discharging device according to an embodiment of the present disclosure.

Referring to FIG. 5, the X-axis slider 251 is configured to move an item 102 in an X-axis direction. To do so, the X-axis slider 251 may be coupled to a clamp 201 configured to lift and fix an item 102 to be loaded or discharged and the fork 202 which is a portion on which the item 102 is placed. For example, at least one clamp 201 may be attached to a portion of the fork 202, and the loading/discharging device 200 may control the clamp 201 to fix the item 102 placed on the fork 202 not to move.

According to an embodiment of the present disclosure, the X-axis slider 251 may move within a corresponding range of ±100 mm in the X-axis direction.

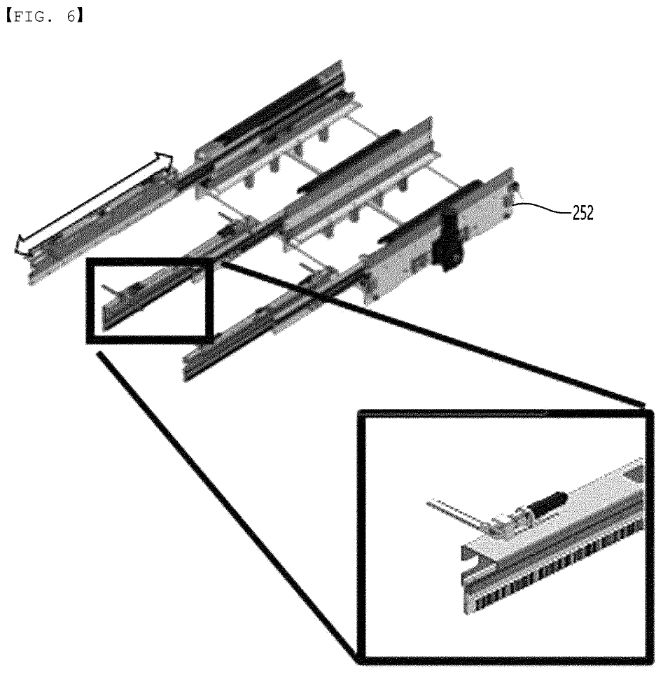

Referring to FIG. 6, the Y-axis fork 252 is configured to move the item 102 in a Y-axis direction. To do so, the Y-axis fork 252 may be coupled to move on the X-axis slider 251 to be perpendicular to a moving direction of the X-axis slider 251.

According to an embodiment of the present disclosure, the Y-axis fork 252 may be configured as a plurality of Y-axis forks, and each Y-axis fork may be configured to have several sections. The mechanical part 250 may control the sections to slide relative to each other or be unfolded to thereby move an item in the loading/discharging device 200 along a Y axis.

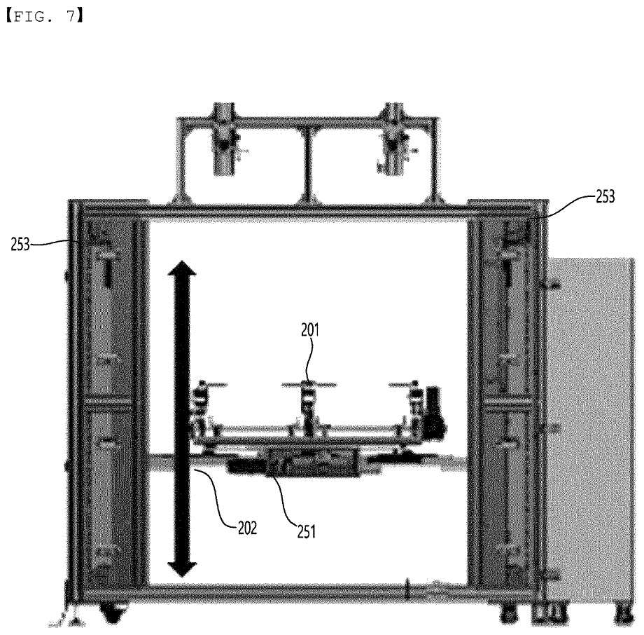

Referring to FIG. 7, the Z-axis lift 253 is configured to move an item in a Z-axis direction. To do so, the Z-axis lift 253 is provided as two Z-axis lifts 253 to be connected to both sides of the fork 202. Each Z-axis lift may move upward and downward while sliding along a rail.

According to an embodiment of the present disclosure, it is described that two Z-axis lifts 253 are provided. However, to increase coupling with the fork 202, a greater number of Z-axis lifts may be configured to be coupled to other regions of the fork 202.

According to an embodiment of the present disclosure, the Z-axis lift 253 may move in a corresponding range of ±1100 mm in the Z-axis direction.

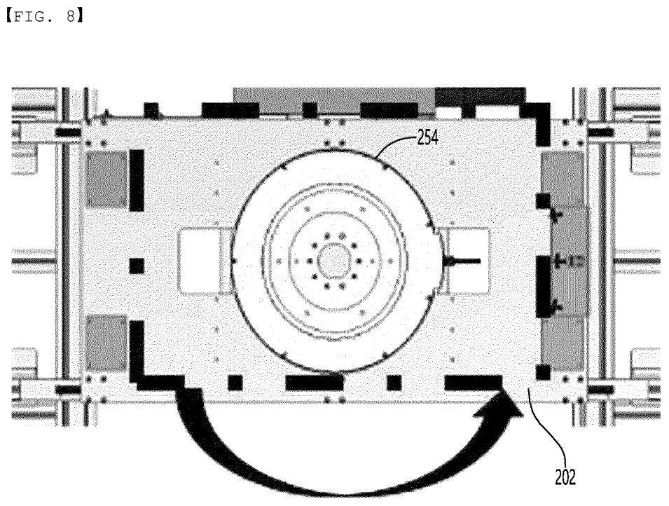

Referring to FIG. 8, the swing fork 254 may include a device that rotates in a left-and-right direction. Additionally, the swing fork 254 may be combined with the fork 202 to rotate an item positioned on the fork 202 at a set angle.

According to an embodiment of the present disclosure, the swing fork 254 may rotate within a corresponding range of ±10°.

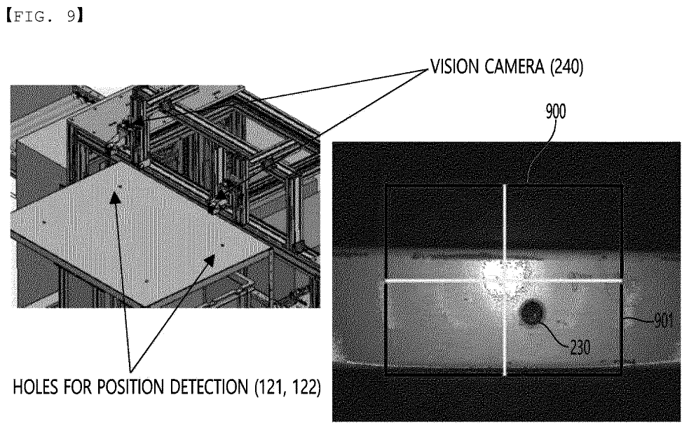

FIG. 9 is a diagram illustrating a vision image captured to check a position of an item in the loading/discharge device according to an embodiment of the present disclosure.

Referring to FIG. 9, when it is determined that the rack 101 has been docked, the loading/discharging device 200 may control the vision camera 240 to obtain a vision image 900 of the rack 101. The vision image 900 may include an image of the rack 101 and sensor data obtained according to detection by an alignment sensor when the vision image 900 is captured. The sensor data may be data indicating a position and an alignment state of a preset object (e.g., the rack 101 or holes 121 and 122).

According to an embodiment of the present disclosure, the loading/discharging device 200 may analyze the vision image 900 to determine whether the docked rack 101 is located at a position that is set previously. For example, the loading/discharging device 200 may set a first reference position 901 based on a position of the vision camera 240 in the vision image 900 and determine whether an image of the rack 101 is captured within a certain range from the first reference position 901 to determine whether the rack 101 is located at the set position.

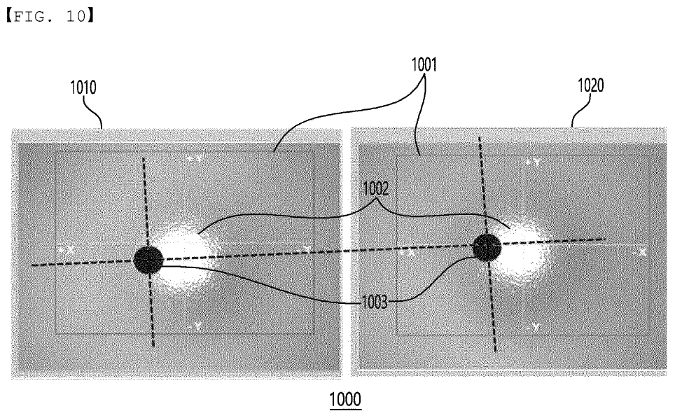

FIG. 10 is a diagram illustrating a vision image captured to determine a hole position spaced apart from a reference position in the loading/discharge device according to an embodiment of the present disclosure.

According to an embodiment of the present disclosure, when a position of the rack 101 is identified using the vision image 900, the loading/discharging device 200 may obtain a vision image 1000 for a hole position 1002 with respect to the holes 121 and 122 included in the rack 101 to determine whether the rack 101 is located apart.

Referring to FIG. 10, the vision image 1000 is obtained using a plurality of lenses arranged at different positions to photograph a plurality of the holes 121 and 122 and a plurality of alignment sensors corresponding to the plurality of lenses, and may include a first vision image 1010 obtained by photographing the first hole 121 and a second vision image 1020 obtained by photographing the second hole 122 in the rack 101.

According to an embodiment of the present disclosure, based on the vision image 1000, the loading/discharging device 200 may set a second reference position 1001 with reference to the hole position 1002 and determine a position 1003 of photographing by the vision camera 240 on the vision image 1000. The photographing position 1003 may include a plurality of position points corresponding to the plurality of lenses of the vision camera 240, respectively.

According to an embodiment of the present disclosure, the loading/discharging device 200 may calculate a distance and an angle by which the photographing position 1003 is located apart from the hole position 1002 in the second reference position 1001. Then, the loading/discharging device 200 may check a correction value including the calculated distance and angle, and control the mechanical part 250 according to the correction value.

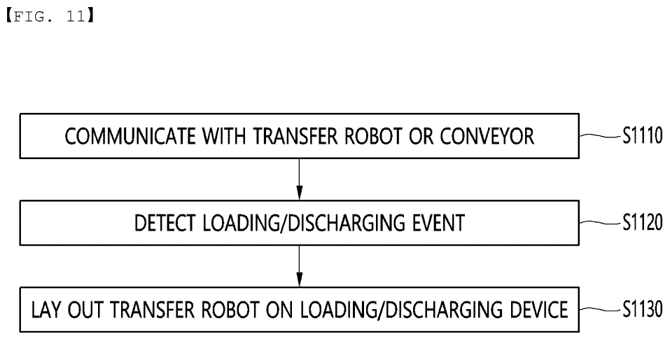

FIG. 11 is a flowchart illustrating an operation of automating, by the loading/discharge device, loading and discharging in the logistics system according to an embodiment of the present disclosure.

Referring to FIG. 11, in operation S1110, the loading/discharging device 200 may perform communication with the transfer robot 100 or the conveyor 300.

In operation S1120, the loading/discharging device 200 may detect a loading/discharging event that has occurred in the transfer robot 100 or the conveyor 300 as a result of the performance of the communication described above. The loading/discharging event may be a control command for discharging an item loaded on the rack 101, attached to the transfer robot 100, to the conveyor 300, or loading an item that has been fed to the conveyor 300 onto the rack 101.

In operation S1130, the loading/discharging device 200 may lay out the transfer robot 100 to dock the rack 101 on the loading/discharging device 200. In the operation of the laying out, the loading/discharging device 200 may control the transfer robot 100 to be moved and positioned according to a position and an alignment state in correspondence with the corresponding loading/discharging event.

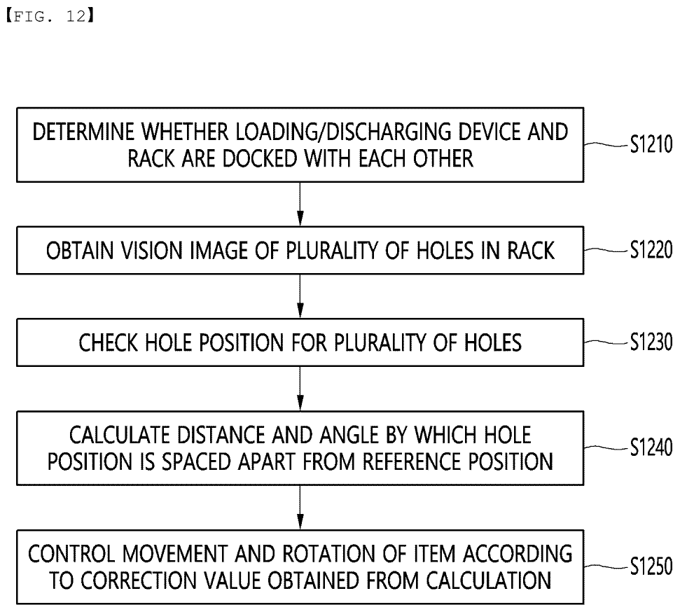

According to an embodiment of the present disclosure, after performing the operation of the laying out, the loading/discharging device 200 may obtain a vision image and move the item placed on the rack 101 or the conveyor 300. A detailed description of this operation is to be provided later in a description with reference to FIG. 12.

FIG. 12 is a flowchart illustrating an operation of moving, by the loading/discharge device, an item based on a vision image in the logistics system according to an embodiment of the present disclosure.

Referring to FIG. 12, in operation S1210, as the transfer robot 100 is laid out, the loading/discharging device 200 may determine whether the rack 101 has been docked on the loading/discharging device 200.

When it is determined that the rack 101 has been docked on the loading/discharging device 200 as a result of performing operation S1210, the loading/discharging device 200 may obtain a vision image of a plurality of holes 121 and 122 in the rack 101 in operation S1220.

In operation S1230, the loading/discharging device 200 may check a hole position for the plurality of holes 121 and 122.

In operation S1240, the loading/discharging device 200 may calculate a distance and an angle by which the hole position is spaced apart from a reference position.

In operation S1250, the loading/discharging device 200 may check a correction value including the calculated distance and angle, and control movement and rotation of the item according to the correction value. For example, the loading/discharging device 200 may move the fork 202 on which the item is placed to a height corresponding to the hole position, and control the mechanical part 250 to move and rotate the fork 202 that has been moved to the hole position by the distance and the angle according to the correction value. Then, the loading/discharging device 200 may control the mechanical part 250 to discharge the item that has been moved and rotated according to the correction value to the conveyor 300 or loaded onto the rack 101.

According to a logistics system and method for automating loading/discharging using a transfer robot in the present disclosure, an effect of reducing labor costs and reducing a possibility of occurrence musculoskeletal diseases and safety accidents to workers by automating a process of loading and discharging items may be obtained.

In addition, in the present disclosure, as loading and discharging are automated in a logistics system, same productivity within the working hours may be ensured. Thus, an effect of predicting a throughput in the logistics system and increasing operational stability may be obtained.

Effects of the present disclosure are not limited to the effects description described above, and other effects may be understood based on the following description, and clearly based on embodiments of the present disclosure.

However, this is only an exemplary embodiment for achieving an object of the present disclosure, and it is obvious that some operations may be added or deleted as needed, and one operation may be included in another operation to be performed.

Although the embodiments of the present disclosure have been described with reference to the accompanying drawings, it will be understood by those skilled in the art that various modifications may be made without departing from the technical scope of the present disclosure and without changing essential features. Therefore, the above-described embodiments should be considered in a descriptive sense only and not for purposes of limitation.

What is claimed is:

1. A logistics system configured to automate loading and discharging using a transfer robot, the logistics system comprising:
a transfer robot configured to perform loading or discharging on a rack and move to a set position; and
a loading/discharging device arranged at one side of a conveyor, and comprising a mechanical part configured to discharge an item loaded on the rack to the conveyor or load an item fed to the conveyor on the rack by moving the item.

2. The logistics system of claim 1, wherein the mechanical part comprises:
a clamp configured to lift and fix the item;
an X-axis slider, a Y-axis fork and a Z-axis lift configured to move a position of the item fixed to the clamp along an X-axis, a Y-axis and a θ-axis, respectively, in correspondence with position information which is set previously; and
a swing fork configured to transfer the item fixed to the clamp at an angle corresponding to the set position information.

3. The logistics system of claim 2, wherein the loading/discharging device is configured to:
detect occurrence of a loading/discharging event for discharging or loading the item by performing communication with the conveyor or the transfer robot; and
further comprise a processor configured to lay out the transfer robot to dock the rack on the loading/discharging device, as the loading/discharging event occurs.

4. The logistics system of claim 3, wherein the loading/discharging device further comprises a vision camera configured to obtain a vision image, and
when the rack is docked on the loading/discharging device, the processor controls the vision camera to obtain a vision image for a plurality of holes provided in the rack.

5. The logistics system of claim 4, wherein the processor is configured to:
identify a hole position for the plurality of holes based on the vision image;
calculate a distance and an angle by which the hole position is spaced apart from a preset reference position; and
transmit a correction value comprising the calculated distance and angle to the mechanical part.

6. The logistics system of claim 5, wherein, when the loading/discharging event is a first loading/discharging event for discharging a first item from the rack, the processor controls the Z-axis lift to move the mechanical part to a height corresponding to the hole position.

7. The logistics system of claim 6, wherein when the mechanical part moves to the hole position, the processor controls the clamp to fix the first item.

8. The logistics system of claim 7, wherein the processor controls the X-axis slider, the Y-axis fork and the swing fork to move and rotate the first item fixed to the clamp by a distance and an angle according to the correction value.

9. The logistics system of claim 8, wherein the processor controls the mechanical part to discharge the first item that has been moved and rotated according to the correction value to the conveyor.

10. The logistics system of claim 5, wherein, when the loading/discharging event is a second loading/discharging event for loading a second item that has been fed to the conveyor onto the rack, the processor controls the clamp to fix the second item.

11. The logistics system of claim 10, wherein the processor controls the Z-axis lift to move the second item fixed to the clamp to a height corresponding to the hole position.

12. The logistics system of claim 11, wherein the processor controls the X-axis slider, the Y-axis fork and the swing fork to move and rotate the second item fixed to the clamp by a distance and an angle according to the correction value.

13. The logistics system of claim 12, wherein the processor controls the mechanical part to load, onto the conveyor, the second item that has been moved and rotated according to the correction value.

14. A method of automating loading and discharging using a transfer robot in a loading/discharging device of a logistics system, the method comprising:
communicating with a transfer robot attached to a conveyor or a rack connected to the loading/discharging device;
as a result of the communication, detecting occurrence of a loading/discharging event for discharging an item loaded on the rack to the conveyor or loading the item that has been fed to the conveyor on the rack; and
laying out the transfer robot to dock the rack on the loading/discharging device, as the loading/discharging event occurs.

15. The method of claim 14, further comprising, when the rack is determined as having been docked on the loading/discharging device, obtaining a vision image of a plurality of holes provided in the rack using a vision camera.

16. The method of claim 15, further comprising:
identifying a hole position for the plurality of holes based on the vision image;
calculating a distance and an angle by which the hole position is spaced apart from a preset reference position; and
checking a correction value comprising the calculated distance and angle.

17. The method of claim 16, further comprising controlling the item to be moved to a height corresponding to the hole position, the item that has been moved to the hole position to be moved and rotated by a distance and an angle according to the correction value, and the item that has been moved and rotated according to the correction value to be discharged to the conveyor or loaded on the rack, by using a mechanical part of the loading/discharging device.
